(19) United States
(12) Patent Application Publication
(10) Pub. No.: US 2004/0003093 A1
(43) Pub. Date: Jan. 1, 2004

(54) Method for providing asynchronous communication over a connected channel without keep-alives

(75) Inventor: Shripathi Kamath, Mission Viejo, CA (US)

Correspondence Address: Lorraine Barrett, Suite E, 15520 Rockfield Blvd., Irvine, CA, 92618, US

(73) Assignee: NETAPHOR SOFTWARE, INC.

(21) Appl. No.: 10/393,474

(22) Filed: Mar. 20, 2003

Related U.S. Application Data
(60) Provisional application No. 60/368,323, filed on Mar. 27, 2002.

(51) Int. Cl. G06F 15/16

(52) U.S. Cl. 709/227

(57) ABSTRACT

A method for providing asynchronous communication over a connected channel with out keep-alives is disclosed. This communication method includes establishing an asynchronous connection between the client and the server. This connection remains open, allowing the server to continue to respond to the original client request. The server continues to send asynchronous responses to the client as network events occur, over this open connection. The client continues to listen for responses over this same open connection.

### CROSS-REFERENCE TO RELATED APPLICATIONS

This application claims priority from U.S. Provisional Application Serial No. 60/368,323, filed Mar. 27, 2002, by Kamath, entitled “Method for Providing Asynchronous Communications Over a Connected Channel With Out Keep-Alives”.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

i) Field of the Invention

The present invention relates to mechanisms for providing asynchronous communication over a connected channel without keep-alives.

ii) Description of Prior Art

HTTP is a well-known protocol today. HTTP is a request-response protocol, where the client must make a request to receive a response from the server. HTTP is also half-duplex. A complete request from a client has to be processed by the server and a response is then made to that request. In HTTP/1.0 a connection is opened and closed for each request/response. This is known to be wasteful. In HTTP/1.1 the connection may remain open but requests and responses must still follow the fundamental rules of make a request, then receive a response, make a request, then receive a response. . . . Clients cannot receive asynchronous responses from the server.

Therefore, there is a need for a method of providing asynchronous communications over a connected channel so clients can be updated of network events for which they are interested without having to have previously made a request for each of these asynchronous responses.

XML information is known from “Extensible Markup Language (XML) 1.0 (Second Edition)”, T. Bray, J. Paoli, C. M. Sperberg-McQueen, E. Maler, editors, Oct. 6, 2000. HTTP information is known from T. Berners-Lee et al., Hypertext Transfer Protocol—HTTP/1.0, Network Computing Group, RFC 1945, pp. 1-60, May 1996.

### BRIEF SUMMARY OF THE INVENTION

In one aspect of the present invention, a method is provided for providing asynchronous communication over a connected channel with out keep-alives. This process involves establishing an asynchronous connection between the client and the server. This connection is kept open. The process further involves the client requesting specific asynchronous data from the server. The server then sends the requested asynchronous data to the client over the established connection as events occur. The client listens for and receives the asynchronous data from the server.

This brief summary has been provided so that the nature of the invention may be understood quickly. A more complete understanding of the invention can be obtained by reference to the following detailed description of the preferred embodiments thereof, in connection with the attached drawings.

### BRIEF DESCRIPTION OF THE DRAWINGS

FIG. 1 is a diagram of a network architecture that may be used to implement the present invention.

FIG. 2 is a diagram of a system or workstation that may be used to implement the present invention.

FIG. 3 is a block diagram of an internal architecture on the workstation that may be used to implement the present invention.

FIG. 4 is a block diagram of a system for providing asynchronous communication over a connected channel without keep-alives, according to one aspect of the present invention.

FIG. 5 is a block diagram showing a typical HTTP/1.0 transaction, according to one aspect of the present invention.

FIG. 6 is a block diagram showing establishment of an asynchronous channel, according to one aspect of the present invention.

FIG. 7 is a block diagram showing initiation of an asynchronous transaction, according to one aspect of the present invention.

FIG. 8 is a flowchart showing establishment of an asynchronous channel, according to one aspect of the present invention.

FIG. 9 is a code snippet showing establishment of an asynchronous channel, according to one aspect of the present invention.

FIG. 10 is a flowchart showing initiation of an asynchronous transaction, according to one aspect of the present invention.

FIG. 11 is a code snippet showing initiation of an asynchronous transaction, according to one aspect of the present invention.

FIG. 12 is a flowchart showing asynchronous responses, according to one aspect of the present invention.

Features appearing in multiple figures with the same reference numeral are the same unless otherwise indicated.

### DETAILED DESCRIPTION OF THE INVENTION

Definitions and Brief Description of Terms

The following definitions are used in various aspects of the present invention with respect to computer networks (but not exclusively):

“HTTP”: HTTP, Hyper Text Transfer Protocol, is a protocol used to request and transmit files over the Internet or other computer network. This protocol is used to transfer requests and responses between servers and browsers.

“XML”: XML, Extensible Markup Language, is a metalanguage written in SGML (Standard Generalized Markup Language) that is used to design a markup language. This is used to allow for the interchange of documents on the World Wide Web.

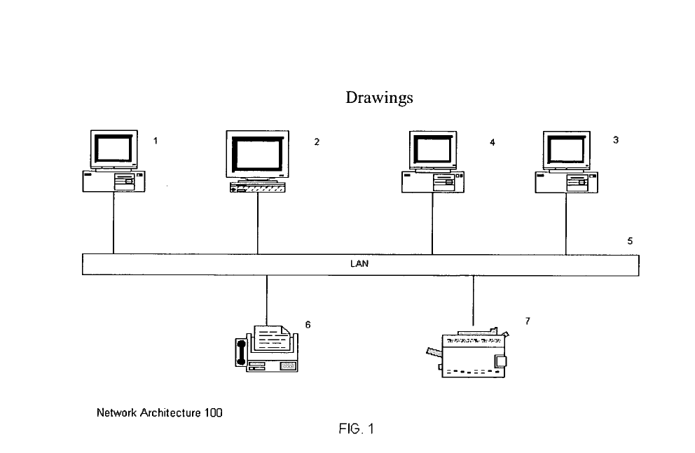

To understand the various adaptive aspects of the present invention, a brief description of a network, a system containing the invention and a block diagram of the internal architecture of the system is provided with respect to FIGS. 1 through 3.

Turning in detail to FIG. 1, network architecture 100 is shown that may be used to implement the various adaptive aspects of the present invention. Plural computer workstations, such as 1, 2, 3 and 4 are connected to the local area network (LAN) 5. Workstations 1, 2, 3 and 4 may each comprise a standard workstation PC. Other workstations, such as Unix workstations may also be included in the network and could be used in conjunction with workstations 1, 2, 3 and 4.

Workstations, such as 1, 2, 3 or 4, may be able to communicate with networked peripherals such as 6 and 7.

One skilled in the art can appreciate that the foregoing devices are coupled to the LAN 5 through a LAN interface (not shown) such as an Ethernet interface 10 Base-2 with a Coax connector or 10 Base-T with an RJ-45 connector. The present invention may also use LAN Token-Ring architecture.

Typically, a LAN serves a localized group of users within the same building. As users become more remote from one another, for example, in different buildings, a wide area network (WAN) (not shown) may be created. In one aspect, the present invention may be adapted to operate with a WAN.

LAN 5 supports data packets transmitted according to the TCP/IP network protocol (IP-packets). Each of these packets includes a destination field, a source field, a data field, a field indicating the length of the data field, and a checksum field. It is noteworthy that the present invention is not limited to TCP/IP but may be implemented using other communication protocols as well.

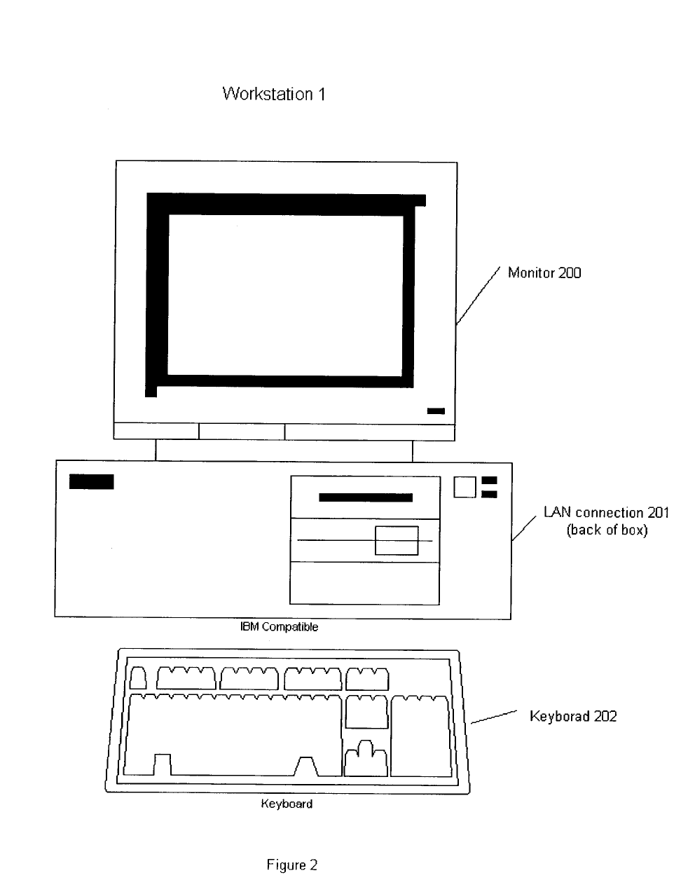

FIG. 2 is an outward view showing a representative workstation (Workstation 1) embodying the present invention. Workstation 1 may operate under various operating systems, e.g., Microsoft Windows NT, Microsoft Windows 2000 or Sun Microsystems Solaris. Workstation 1 includes a monitor with display area 201 that may be used to display information, workstation 1 also contains a keyboard 203 that can be used for inputting commands and/or data.

Workstation 1 interfaces with LAN 5 via connection 202, (not shown—on the back of the box).

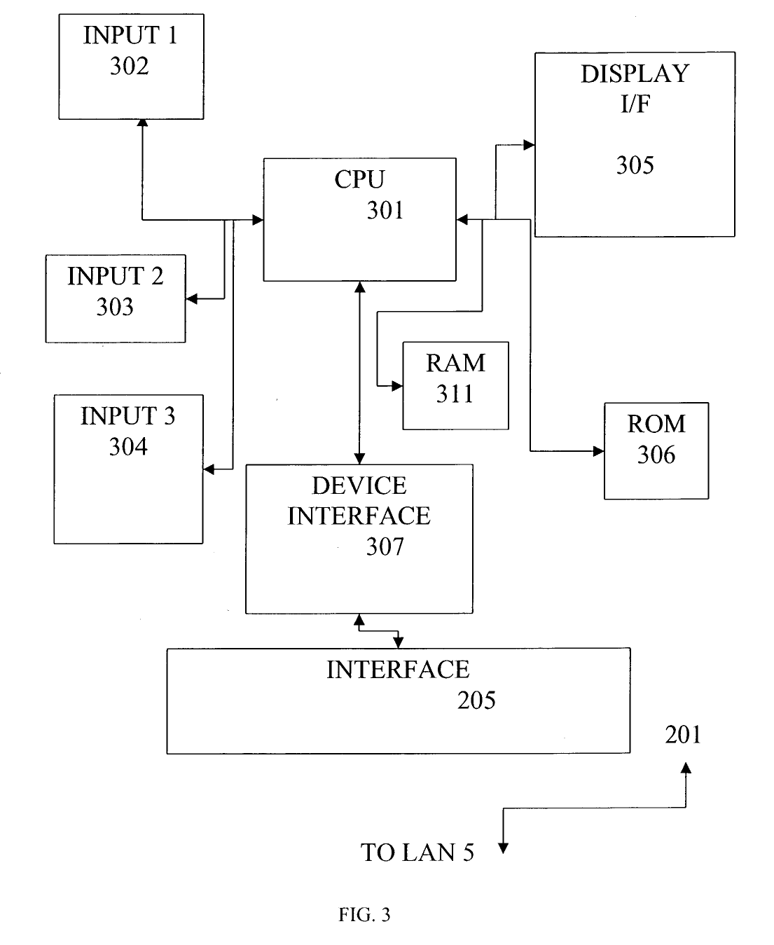

FIG. 3 is a block diagram showing the internal functional architecture of workstation 1. As shown in FIG. 3, workstation 1 includes central processing unit (“CPU”) 301 that interfaces with various components described below and is used for executing computer-executable process steps including those discussed below.

CPU 301 may receive input from various sources including a keyboard 202 via a keyboard interface 302, mouse 203 via mouse interface 303; and other external sources, via interface 304.

CPU 301 also interfaces with device interface 307 that allows workstation 1 to be connected to a LAN via interface 205.

CPU 301 also interfaces with a display interface 305 for displaying data in display area 202.

A random access main memory (“RAM”) 311 also interfaces with CPU 301 to provide CPU 301 with access to memory storage. When executing stored computer-executable process steps CPU 301 stores those process steps in RAM 311 and executes the stored process steps out of RAM 311.

Read only memory (“ROM”) 306 is provided to store invariant instruction sequences such as start-up instruction sequences or basic input/output operating system (BIOS) sequences. ROM 306 may also store basic programs, e.g., address book, calendar, memo pads and the operating system.

An Asynchronous Notification System

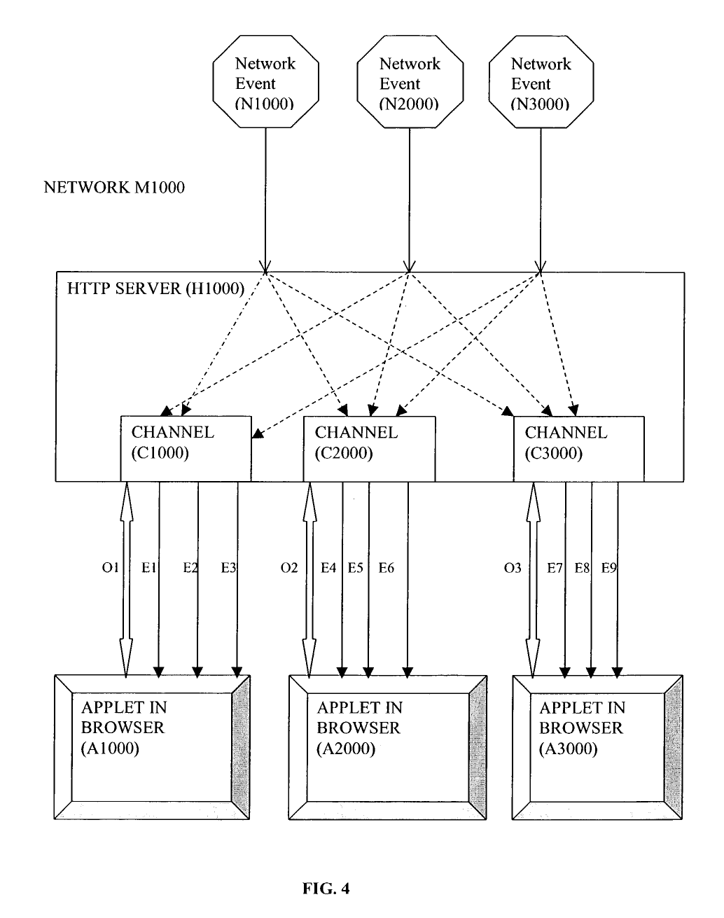

FIG. 4 is a top-level block diagram of a system for providing asynchronous communication over a connected channel without keep-alives.

FIG. 4 shows a HTTP server H1000 that monitors the network M1000 for network events such as N1000, N2000 or N3000, that could be generated by Workstation 1,2,3,4 or Networked Peripherals 6,7 in FIG. 1. HTTP clients, such as the applets A1000, A2000 and A3000, which require asynchronous notification of the network events, establish an asynchronous channel with the server H1000 using transactions 01, 02 and 03. The HTTP server H1000 preserves a correspondence between the channel and the socket used to create the channel, and writes the network responses to that socket as they come in, delimited appropriately. Thus the network event N1000 is transformed into the event E1 sent to applet A1000, the event E4 sent to applet A2000 and the event E7 sent to applet A3000.

The system may have more sub-modules or have all the modules integrated in various ways.

Asynchronous Method

The present invention relates to a system for communication between a client and a server using asynchronous communications over a standard HTTP connection as shown in FIG. 5.

In regard to the present invention two key points characterize the HTTP protocol:

It is a request-response protocol. This means that as specified, one cannot get unsolicited information back using HTTP. One has to make a request, and only then receive a response. A response or more appropriately a notification cannot be sent without a preceding request.

HTTP is half-duplex. A complete request has to be processed, and a response is made to that request. In HTTP/1.0 each connection represents the processing of a single request. A client opens a connection, and sends a request to the server, and the server sends a response, and then closes the connection. The cost of opening and closing connections is quite wasteful, and HTTP/1.1 addresses this by allowing the connection to be kept open. In this scenario, a client opens a connection, and sends a request, the server responds, but does not close the connection. The client may then engage in subsequent request-response scenarios over the same connection, AS LONG AS it does so following the fundamental rule of make a request, get a response, make a request, get a response, all in order. Note that under HTTP/1.1, a client may pipeline multiple requests, but the responses always come back in order. Either the client or the server may close the connection; typically it is the client. A server only closes a connection under HTTP/1.1 under exceptional circumstances.

The technique used by the present invention is based on the HTTP/1.0 protocol, FIG. 5.

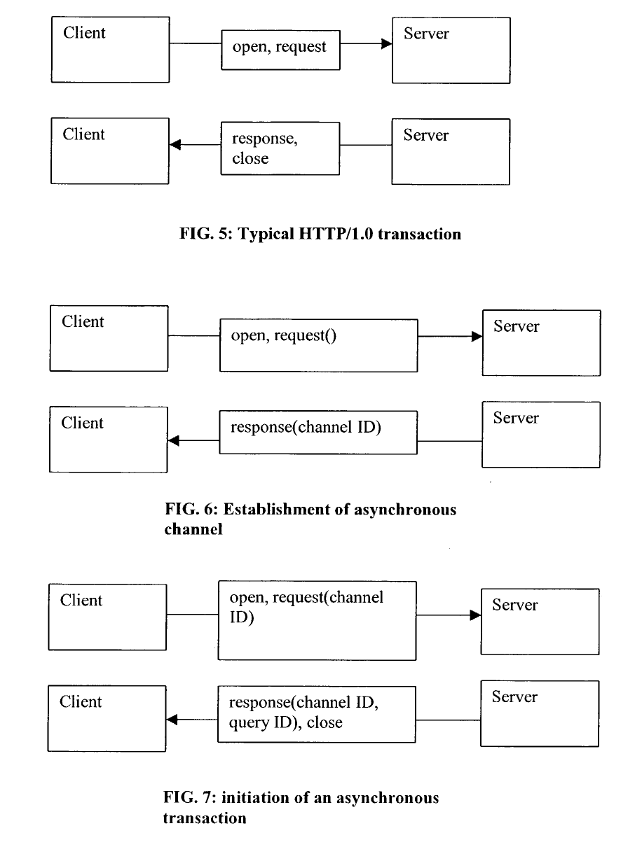

The first task is to establish an asynchronous connection between the client and the server as shown in FIG. 6 and described in detail below. This is done by the client sending an HTTP request requesting establishment of an asynchronous channel. When the server receives a request for such an HTTP/1.0 connection, it registers the client, and generates an associated handle (channel ID) for the client connection. As a response, the server sends back a response with this channel ID in the response. The client stores this channel ID away, associating it with the asynchronous channel. NOTE THAT THE SERVER DOES NOT CLOSE THE CONNECTION, instead simply indicates to the client that more of the response is to follow. This does not violate the HTTP/1.0 protocol, it simply makes the response appear to be VERY slow, or alternatively appear to be a VERY long.

The above constitutes the establishment of an asynchronous channel between the client and the server as shown in FIG. 6. Note that nothing more can be said by the client on that channel, but the server can, since it did not close the connection.

Now subsequently, the client needs to receive asynchronous data from the server, it simply waits for data to appear on the asynchronous channel, and proceeds to deal with it as it pleases.

Clients make use of this asynchronous channel to initiate asynchronous transactions as shown in FIG. 7 and detailed below. To do this, the client simply opens another HTTP channel, sends a request with the channel ID described above, and the body of its request. The server, notes the channel ID, generates a query ID for the asynchronous transaction, sends an acknowledgement response back to the client for its request, and closes the connection. It then performs the request, and sends back the requested data over the asynchronous channel, along with the query ID, the same one that was given to it in the initiating request.

Note that multiple logical asynchronous channels can be built on top of a single connection, by the use of these query IDs.

Establishing the Asynchronous Channel

The transactions 01, 02 and 03 in the system diagram in FIG. 4 show the client applets A1000, A2000 and A3000 establishing an asynchronous channel with the HTTP server H1000.

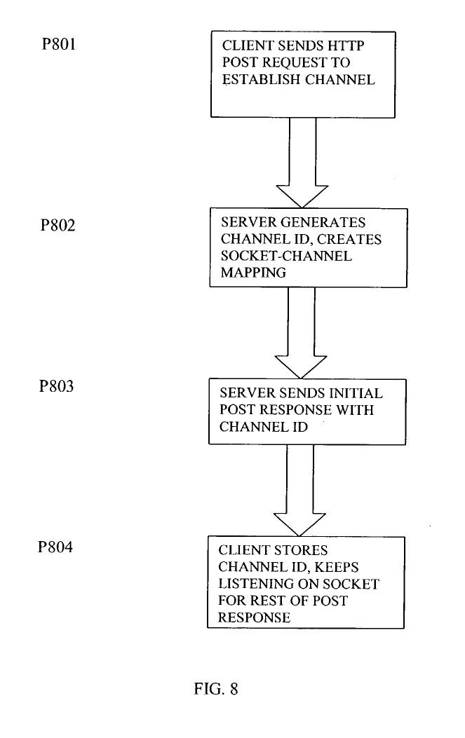

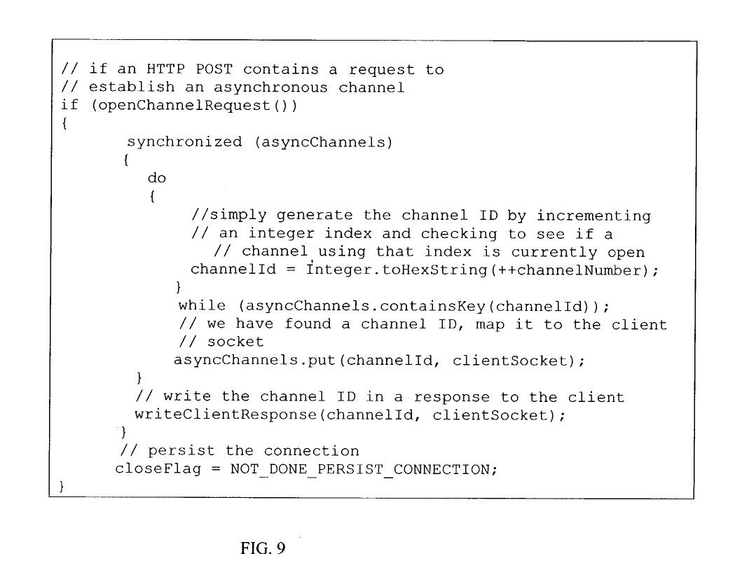

P801 of FIG. 8 shows the HTTP client sending a request to open the asynchronous channel using a HTTP POST. The request to open the channel is sent embedded in the message body of the POST, and uses some suitable encoding format, such as an XML-based markup.

P802 of FIG. 8 shows the HTTP server processing the request to open the asynchronous channel. At this stage, the HTTP server uses any suitable mechanism for generating a channel ID (a simple mechanism for this purpose is explained in the description for FIG. 9). The server then maps the created channel ID to the client socket ID, and stores this mapping for later use.

P803 of FIG. 8 shows the HTTP server sending the initial POST response. This response contains the channel ID created in P802 and is also sent using a suitable encoding format, such as an XML-based markup. The server does not indicate that the POST response is complete at this point, and does not close the client socket. This encoding format is designed in order to ensure that the channel ID is clearly delimited in the POST response.

P804 of FIG. 8 shows the HTTP client reading the response sent by the server containing the channel ID. Since the channel ID is clearly delimited, the client is able to read and store the channel ID for future use with the asynchronous channel. After reading the channel ID, the client does not close the socket but rather continues listening on it for the rest of the POST response.

FIG. 9 shows a Java implementation of the server processing required on establishment of the asynchronous channel. If a request is received for opening such a channel, the server in FIG. 9 uses a simple incrementing mechanism to find an integer token which is free to be used as a channel ID. Having thus created a channel ID, the server creates a mapping of the channel ID to the client socket. It then writes the channel ID in a response to the client, but persists the HTTP connection after this response is written.

Initiation of an Asynchronous Query

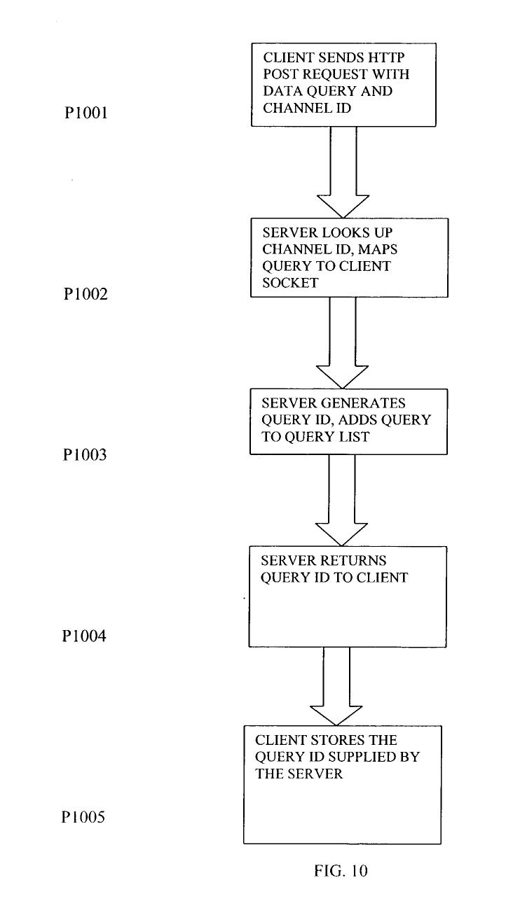

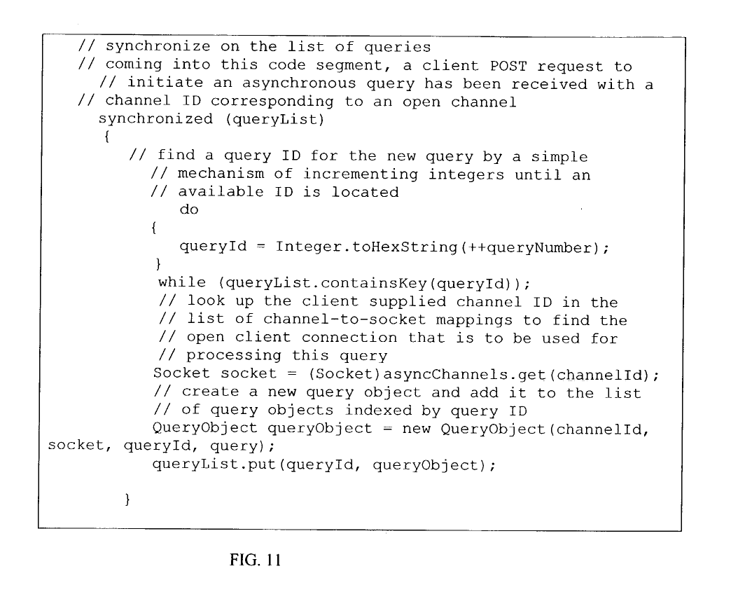

P1001 of FIG. 10 shows the client initiating a request for asynchronous data by sending a POST request containing the channel ID of an open channel and a description of the type of asynchronous data that is requested. This request is embedded in the message body of the POST and can be encoded using any suitable format, such as an XML-based markup. The channel ID contained in this request must refer to a channel that has been established previously by following the steps listed in the description of FIG. 11.

P1002 of FIG. 10 shows the server decoding the message body of the POST and extracting the channel ID that has been supplied by the client. The server then proceeds to look up this channel ID in its list of channel ID to socket mappings and locate the client socket that must be used for asynchronous responses to this query.

P1003 of FIG. 10 shows the server generating a query ID for the query, using any simple token generation scheme such as the one explained in the description of FIG. 11. The server also creates a query object based on the data requested by the client, and stores a set of query ID to query object mappings.

P1004 of FIG. 10 shows the server sending a response to the POST request containing the channel ID and the newly generated query ID. This response can contain the two IDs embedded using any suitable encoding format, such as an XML-based markup.

P1005 of FIG. 10 shows the client processing the POST response. The client extracts the query ID supplied by the server and stores it for cross-referencing future asynchronous responses from the server to the queries that they are being sent in response to.

FIG. 11 shows a Java implementation of the server's processing for asynchronous query initiation. The server first generates a query ID using a simple scheme for locating an integer index that is not currently used by an open query. The server then looks up the client supplied channel ID in its list of channel ID to client socket mappings, and retrieves the client socket that is to be used in sending asynchronous responses to this query. Finally, the server creates a query object using the client supplied data request, and the newly generated query ID, and stores the query object in a list of query ID to query object mappings.

Asynchronous Responses

The system diagram in FIG. 4 shows the asynchronous events E1 to E9 being generated by the network events N1000, N2000 and N3000.

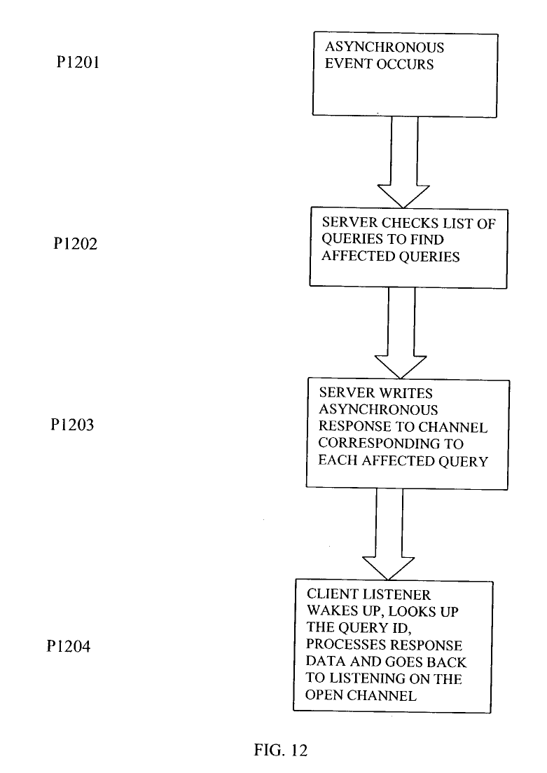

P1201 of FIG. 12 shows an asynchronous event happening in the network. This event affects data that the server is interested in, and is being monitored by the server. Hence, the server records the event, and initiates the process of notifying all clients that requested to be notified on such an event.

P1202 of FIG. 12 shows the server examining all the query objects that it has stored, in order to determine all the connected clients that have requested notification on occurrence of the asynchronous event. At the end of this step, the server has a set of query IDs and, for each query ID, a channel ID corresponding to the channel that is to be used for asynchronous communications with that client.

P1203 of FIG. 12 shows the server writing the asynchronous response to the client. In order to do this, the server looks up the channel ID in its list of channel ID to socket mappings and finds the client socket that is to be used for writing this asynchronous response. Once the client socket is determined, the server creates a response document that contains the channel ID, the query ID and the data concerning the asynchronous event, all of which have been encoded using any suitable format, such an XML-based markup. The server then writes this response document to the client socket.

P1204 of FIG. 12 shows the client, which has been listening on the socket for the rest of the response to the initial query establishing the channel, waking up to receive the asynchronous response from the server. The client extracts the query ID from the response to determine the nature of the asynchronous event, and the data encoded in response to get further information about the asynchronous event. While processing this information, the client continues to listen on the socket as the server did not indicate that the response was complete or close the connection. Thus multiple such asynchronous responses can be sent to the client over the same channel, each time an asynchronous event occurs.

While the present invention is described above with respect to what is currently considered its preferred embodiments, it is to be understood that the invention is not limited to that described above.

What is claimed is:

1. A method for providing asynchronous communication over a connected channel with out keep-alives, comprising:
establishing an asynchronous connection between a client and a server, over a standard HTTP connection, in which the client makes the request and the server responds to the request with a channel ID (for this connection) and leaves the connection open.

2. The method of claim 1, further comprising:
the client, over another HTTP channel, sending a request to the server with the original Channel ID and the request for asynchronous data included in the body of the request.

3. The method of claim 1, further comprising:
the server, in response, returning a Query ID that will be used by the client as a cross-reference when asynchronous queries are received.

4. The method of claim 1, further comprising:
the server, upon event notification from a networked element, determining which clients have requested asynchronous notification of this event, and then sending the asynchronous response to those clients.

5. The method of claim 1, further comprising:
the client, which has been listening on the open channel, wakes up to receive the asynchronous response.
